(19) United States
(12) Patent Application Publication
(10) Pub. No.: US 2018/0007676 A1
(43) Pub. Date: Jan. 4, 2018

(54) METHOD, DEVICE AND SYSTEM FOR UNIFORMLY CONTROLLING MULTIPLE SMART DEVICES

(71) Applicant: ArcherMind Technology (Nanjing) Co., Ltd., Nanjing City (CN)

(72) Inventors: Zonggang Yan, Nanjing City (CN); Lei Wang, Nanjing City (CN)

(73) Assignee: ArcherMind Technology (Nanjing) Co., Ltd., Nanjing City (CN)

(21) Appl. No.: 15/263,693

(22) Filed: Sep. 13, 2016

Related U.S. Application Data
(63) Continuation of application No. PCT/CN2016/089955, filed on Jul. 14, 2016.

(30) Foreign Application Priority Data
Jul. 1, 2016 (CN) 201610515326.7

(51) Int. Cl. H04W 72/04; H04W 4/00; H04W 72/08; H04W 84/12

(52) U.S. Cl. CPC H04W 72/0406; H04W 72/085; H04W 4/008; H04W 84/12

(57) ABSTRACT

The present invention discloses a method, device and system for uniformly controlling multiple smart devices. The method includes: receiving a control instruction for uniformly controlling the multiple smart devices, the control instruction including identifier information of the multiple smart devices to be controlled; acquiring signal noise parameters of the multiple smart devices according to the identifier information; calculating time differences between the multiple smart devices according to the signal noise parameters; formulating a uniform control policy for the multiple smart devices according to the time differences; and controlling the multiple smart devices are controlled according to the uniform control policy. In this way, the multiple smart devices may operate synchronously.

This application is a continuation of International Application No. PCT/CN2016/089955, filed on Jul. 14, 2016, which claims priority to Chinese Patent Application No. 201610515326.7, filed on Jul. 1, 2016, both of which are hereby incorporated by reference in their entireties.

### TECHNICAL HELD

The present invention relates to the smart device technologies, and in particularly, relates to a method, device and system for uniformly controlling multiple smart devices.

### BACKGROUND

With the rapid development of smart devices, in many scenarios, one-key control needs to be employed to operate and control multiple smart devices, that is, it is desired to uniformly control simultaneous switch-on and switch-off of the multiple devices by operating a terminal device.

In the related art, multiple smart devices, for example, multiple smart lamps, are connected to a network device in a wireless communication manner, for example, via a wireless router. The wireless communication manner may be any one of WiFi, Bluetooth and Zigbee. An App is mounted on the terminal device for controlling these smart devices, and a control instruction is sent to the wireless router by controlling the App on the terminal device, such that the wireless router may simultaneously control switch-on and switch off of these smart devices. However, since different smart devices have different hardware features, time differences are present during reception of the switch instruction sent by the wireless router. Therefore, the multiple smart devices may not operate synchronously. For example, the multiple smart lamps are lit at different time points.

### SUMMARY

The present invention is intended to provide a method, device and system for uniformly controlling multiple smart devices, to solve the technical problem that the multiple smart devices may not operate synchronously.

To solve the above technical problem, an embodiment of the present invention provides a method for uniformly controlling multiple smart devices. The method includes:

receiving a control instruction for uniformly controlling the multiple smart devices, the control instruction including identifier information of the multiple smart devices to be controlled; acquiring signal noise parameters of the multiple smart devices according to the identifier information; calculating time differences between the multiple smart devices according to the signal noise parameters; formulating a uniform control policy for the multiple smart devices according to the time differences; and controlling the multiple smart devices according to the uniform control policy.

Optionally, the signal noise parameters of the multiple smart devices include signal voltages Vs and noise voltages Vn of the multiple smart devices, and the calculating time differences between the multiple smart devices according to the signal noise parameters specifically includes:

calculating a transmission rate C of the multiple smart devices according to Shannon's formula C=B*Log2(1+S/N), wherein B denotes a channel bandwidth, signal-to-noise ratio S/N=Ps/Pn=Vs/Vn;

calculating, according to a ratio of a data volume of the control instruction to the transmission rate C, time elapsed for sending the control instruction to the multiple smart devices; and

calculating the time differences between the multiple smart devices according to the calculated time.

Optionally, prior to the receiving a control instruction for uniformly controlling the multiple smart devices, the method further includes:

receiving and storing registration messages sent by the multiple smart devices, the registration messages including the identifier information and the signal noise parameters; and

the acquiring signal noise parameters of the multiple smart devices according to the identifier information specifically includes:

searching, in the stored signal noise parameters, for signal noise parameters corresponding to the identifier information.

Optionally, prior to the receiving a control instruction for uniformly controlling the multiple smart devices, the method further includes:

receiving and storing registration messages sent by the multiple smart devices, the registration messages including the identifier information; and

the acquiring signal noise parameters of the multiple smart devices according to the identifier information specifically includes:

sending a signal noise parameter acquisition request to the multiple smart devices according to the identifier information; and

receiving the signal noise parameters sent by the multiple smart devices.

An embodiment of the present invention further provides a network device, including:

a receiving unit, configured to receive a control instruction for uniformly controlling the multiple smart devices, the control instruction including identifier information of the multiple smart devices to be controlled;

an acquiring unit, configured to acquire signal noise parameters of the multiple smart devices according to the identifier information;

a calculating unit, configured to calculate time differences between the multiple smart devices according to the signal noise parameters;

a formulating unit, configured to formulate a uniform control policy for the multiple smart devices according to the time differences; and

a control unit, configured to control the multiple smart devices according to the uniform control policy.

Optionally, the signal noise parameters of the multiple smart devices include signal voltages Vs and noise voltages Vn of the multiple smart devices, and the calculating unit specifically includes a transmission rate calculating module, a time calculating module and a time difference calculating module, wherein

the transmission rate calculating module is configured to calculate a transmission rate C of the multiple smart devices according to Shannon's formula C=B*Log2(1+S/N), wherein B denotes a channel bandwidth, signal-to-noise ratio S/N=Ps/Pn=Vs/Vn;

the time calculating module is configured to calculate, according to a ratio of a data volume of the control instruction to the transmission rate C, time elapsed for sending the control instruction to the multiple smart devices; and

the time difference calculating module is configured to calculate the time differences between the multiple smart devices according to the calculated time.

Optionally, the receiving unit is further configured to, prior to receiving the control instruction, receive registration messages sent by the multiple smart devices, the registration messages including the identifier information and the signal noise parameters;

the network device further includes a storage unit, configured to store the identifier information and the signal noise parameters; and

the acquiring unit is specifically configured to search, in the stored signal noise parameters, for signal noise parameters corresponding to the identifier information.

Optionally, the receiving unit is further configured to, prior to receiving the control instruction, receive registration messages sent by the multiple smart devices, the registration messages including the identifier information;

the network device further includes a storage unit, configured to store the identifier information; and

the acquiring unit specifically includes a sending module and a receiving module, wherein the sending module is configured to send a signal noise parameter acquisition request to the multiple smart devices according to the identifier information, and the receiving module is configured to receive the signal noise parameters sent by the multiple smart devices.

An embodiment of the present invention further provides a terminal device, including:

a receiving unit, configured to receive operations of a user for uniformly controlling multiple smart devices;

a generating unit, configured to generate a control instruction for uniformly controlling the multiple smart devices according to the operations of the user, the control instruction including identifier information of the multiple smart devices to be controlled;

an acquiring unit, configured to acquire signal noise parameters of the multiple smart devices according to the identifier information;

a calculating unit, configured to calculate time differences between the multiple smart devices according to the signal noise parameters;

a formulating unit, configured to formulate a uniform control policy for the multiple smart devices according to the time differences; and

a sending unit, configured to send a control instruction to which the uniform control policy is added, such that the network device controls the multiple smart devices according to the uniform control policy.

Optionally, the signal noise parameters of the multiple smart devices include signal voltages Vs and noise voltages Vn of the multiple smart devices, and the calculating unit specifically includes a transmission rate calculating module, a time calculating module and a time difference calculating module, wherein

the transmission rate calculating module is configured to calculate a transmission rate C of the multiple smart devices according to Shannon's formula C=B*Log2(1+S/N), wherein B denotes a channel bandwidth, signal-to-noise ratio S/N=Ps/Pn=Vs/Vn;

the time calculating module is configured to calculate, according to a ratio of a data volume of the control instruction to the transmission rate C, time elapsed for sending the control instruction to the multiple smart devices; and

the time difference calculating module is configured to calculate the time differences between the multiple smart devices according to the calculated time.

Optionally, the acquiring unit specifically includes a sending module and a receiving module, wherein the sending module is configured to send a signal noise parameter acquisition request to the network device according to the identifier information, and the receiving module is configured to receive the signal noise parameters sent by the network device.

An embodiment of the present invention further provides a system for uniformly controlling multiple smart devices, including: a terminal device, a network device and the multiple smart devices; wherein

the terminal device is configured to generate, according to operations of a user, a control instruction for uniformly controlling the multiple smart devices, and send the control instruction to the multiple smart devices, the control instruction including identifier information of the multiple smart devices to be controlled; and

the network device is configured to: acquire signal noise parameters of the multiple smart devices according to the identifier information, calculate time differences between the multiple smart devices according to the signal noise parameters, formulate a uniform control policy for the multiple smart devices according to the time differences, and control the multiple smart devices according to the uniform control policy.

Optionally, the multiple smart devices include signal voltages Vs and noise voltages Vn of the multiple smart devices, and the network device is specifically configured to:

calculate a transmission rate C of the multiple smart devices according to Shannon's formula C=B*Log2(1+S/N), wherein B denotes a channel bandwidth, signal-to-noise ratio S/N=Ps/Pn=Vs/Vn;

calculate, according to a ratio of a data volume of the control instruction to the transmission rate C, time elapsed for sending the control instruction to the multiple smart devices; and

calculate the time differences between the multiple smart devices according to the calculated time.

An embodiment of the present invention further provides a system for uniformly controlling multiple smart devices, including: a terminal device, a network device and the multiple smart devices; wherein

the terminal device is configured to: receive operations of a user for uniformly controlling multiple smart devices, and generate, according to the operations of the user, a control instruction for uniformly controlling the multiple smart devices, the control instruction including identifier information of the multiple smart devices to be controlled; and

the terminal device is further configured to: acquire signal noise parameters of the multiple smart devices according to the identifier information, calculate time differences between the multiple smart devices according to the signal noise parameters, formulate a uniform control policy for the multiple smart devices according to the time differences, and send a control instruction to which the uniform control policy is added to the network device such that the network device controls the multiple smart devices according to the uniform control policy.

Optionally, the multiple smart devices include signal voltages Vs and noise voltages Vn of the multiple smart devices, and the terminal device is specifically configured to:

calculate a transmission rate C of the multiple smart devices according to Shannon's formula C=B*Log2(1+S/N), wherein B denotes a channel bandwidth, signal-to-noise ratio S/N=Ps/Pn=Vs/Vn;

calculate, according to a ratio of a data volume of the control instruction to the transmission rate C, time elapsed for sending the control instruction to the multiple smart devices; and

calculate the time differences between the multiple smart devices according to the calculated time.

With the method, device and system for uniformly controlling multiple smart devices according to the embodiments of the present invention, a control instruction for uniformly controlling the multiple smart devices is received, the control instruction including identifier information of the multiple smart devices to be controlled; signal noise parameters of the multiple smart devices are acquired according to the identifier information; time differences between the multiple smart devices are calculated according to the signal noise parameters; a uniform control policy for the multiple smart devices is formulated according to the time differences; and the multiple smart devices are controlled according to the uniform control policy. In this way, the multiple smart devices may operate synchronously.

### BRIEF DESCRIPTION OF THE DRAWINGS

To describe embodiments of the present invention or the technical solution in the related art, hereinafter, drawings that are to be referred for description of the embodiments or the related art are briefly described. Apparently, the drawings described hereinafter merely illustrate some embodiments of the present invention. Persons of ordinary skill in the art may also derive other drawings based on the drawings described herein without any creative effort.

FIG. 1 is a schematic flowchart of a method for uniformly controlling multiple smart devices according to an embodiment of the present invention;

FIG. 2 is a schematic flowchart of a method for uniformly controlling multiple smart devices according to an embodiment of the present invention;

FIG. 3 is a schematic flowchart of a method for uniformly controlling multiple smart devices according to an embodiment of the present invention;

FIG. 4 is a schematic structural diagram of a network device according to an embodiment of the present invention;

FIG. 5 is a schematic structural diagram of a terminal device according to an embodiment of the present invention;

FIG. 6 is a schematic structural diagram of a system for controlling multiple smart devices according to an embodiment of the present invention; and

FIG. 7 is a schematic structural diagram of a system for uniformly controlling multiple smart devices according to an embodiment of the present invention.

### DETAILED DESCRIPTION

To make a person skilled in the art better understand the technical solutions of embodiments of the present invention, the technical solutions of the present invention are clearly and completely described with reference to the accompanying drawings of the embodiments of the present invention. Apparently, the described embodiments are only a part of embodiments of the present invention, rather than the entire embodiments. Based on the embodiments of the present invention, all other embodiments derived by persons of ordinary skill in the art without any creative efforts shall fall within the protection scope of the present invention.

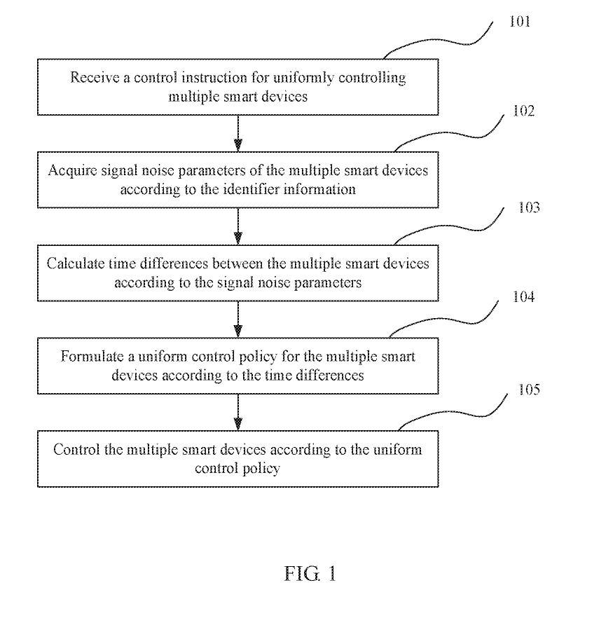

FIG. 1 is a schematic flowchart of a method for uniformly controlling multiple smart devices according to an embodiment of the present invention. The method includes the following steps:

S101: receiving a control instruction for uniformly controlling the multiple smart devices, the control instruction including identifier information of the multiple smart devices to be controlled;

S102: acquiring signal noise parameters of the multiple smart devices according to the identifier information;

S103: calculating time differences between the multiple smart devices according to the signal noise parameters;

S104: formulating a uniform control policy for the multiple smart devices according to the time differences; and

S105: controlling the multiple smart devices according to the uniform control policy.

Optionally, the signal noise parameters of the multiple smart devices include signal voltages Vs and noise voltages Vn of the multiple smart devices, and the calculating time differences between the multiple smart devices according to the signal noise parameters specifically includes:

calculating a transmission rate C of the multiple smart devices according to Shannon's formula C=B*Log2(1+S/N), wherein B denotes a channel bandwidth, signal-to-noise ratio S/N=Ps/Pn=Vs/Vn;

calculating, according to a ratio of a data volume of the control instruction to the transmission rate C, time elapsed for sending the control instruction to the multiple smart devices; and

calculating the time differences between the multiple smart devices according to the calculated time.

Optionally, prior to the receiving a control instruction for uniformly controlling the multiple smart devices, the method further includes:

receiving and storing registration messages sent by the multiple smart devices, the registration messages including the identifier information and the signal noise parameters; and

the acquiring signal noise parameters of the multiple smart devices according to the identifier information specifically includes:

searching for the stored signal noise parameters.

Optionally, prior to the receiving a control instruction for uniformly controlling the multiple smart devices, the method further includes:

receiving and storing registration messages sent by the multiple smart devices, the registration messages including the identifier information; and

the acquiring signal noise parameters of the multiple smart devices according to the identifier information specifically includes:

sending a signal noise parameter acquisition request to the multiple smart devices according to the identifier information; and

receiving the signal noise parameters sent by the multiple smart devices.

With the method, device and system for uniformly controlling multiple smart devices according to the embodiments of the present invention, a control instruction for uniformly controlling the multiple smart devices is received, the control instruction including identifier information of the multiple smart devices to be controlled; signal noise parameters of the multiple smart devices are acquired according to the identifier information; time differences between the multiple smart devices are calculated according to the signal noise parameters; a uniform control policy for the multiple smart devices is formulated according to the time differences; and the multiple smart devices are controlled according to the uniform control policy. In this way, the multiple smart devices may operate synchronously.

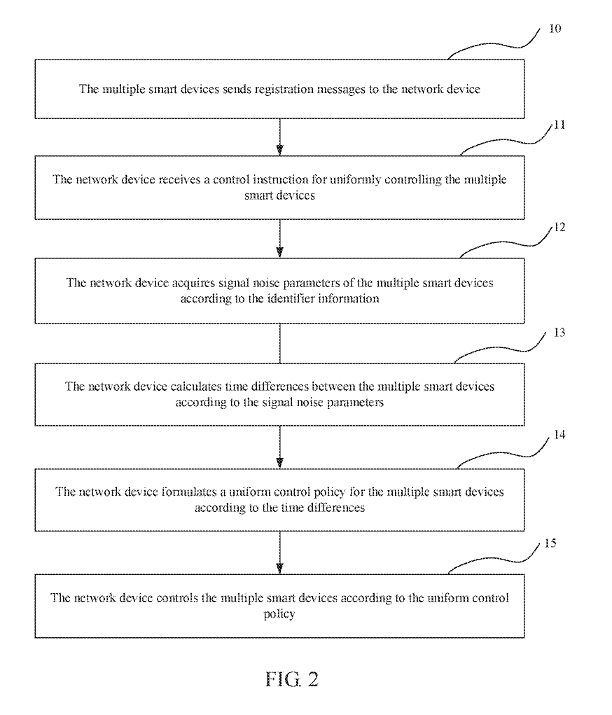

An embodiment of the present invention provides a method for uniformly controlling multiple smart devices. An enforcement object of the method is a network device, for example, a network router. As illustrated in FIG. 2, the method includes the following steps:

Step 11: A network device receives a control instruction for uniformly controlling the multiple smart devices, wherein the control instruction includes identifier information of the multiple smart devices to be controlled.

The control instruction is generated by a terminal device according to operations of a user and sent to the network device. Specifically, the user may perform the operations via an App installed on the terminal device, wherein the App has a graphical user operation interface, and the user may select, via the interface, the multiple smart devices to be controlled; and the terminal device generates the control instruction according to the operations of the user, and sends the control instruction to the network device. The identifier information may be unique device identifiers (UDIDs) of the multiple smart devices or other identifier information identifying the multiple smart devices.

Prior to step 11, the method for uniformly controlling multiple smart devices further includes step 10 in which the multiple smart devices send registration messages to the network device.

The registration messages include the identifier information of the multiple smart devices, and the registration messages may also include signal noise parameters of the multiple smart devices, wherein the signal noise parameters of the multiple smart devices include signal voltages Vs and noise voltages Vn of the multiple smart devices. The network device stores the registration messages, and specifically the registration messages may be stored on the network device, or may be stored on a server or a cloud end connected to the network device, wherein the specific storage location is not limited in the embodiments of the present invention, and any storage location shall fall within the protection scope of the embodiments of the present invention.

Step 12: The network device acquires signal noise parameters of the multiple smart devices according to the identifier information.

Specifically, if the registration messages include the identifier information and the signal noise parameters, the network device searches for the stored signal noise parameters.

If the registration messages do not include the signal noise parameters, the network device sends a signal noise parameter acquisition request to the multiple smart devices according to the identifier information, and receives the signal noise parameters sent by the multiple smart devices.

Step 13: The network device calculates time differences between the multiple smart devices according to the signal noise parameters.

A transmission rate C of the multiple smart, devices is calculated according to Shannon's formula C=B*Log2(1+S/N), wherein B denotes a channel bandwidth, signal-to-noise ratio S/N=Ps/Pn=Vs/Vn. For example, in a radio frequency band of 2.4 GHz, bandwidth B of a WiFi channel is 22 MHz, bandwidth B of a Bluetooth channel is 1 MHz, and bandwidth B of a Zigbee channel is 5 MHz.

Time elapsed for sending the control instruction to the multiple smart devices is calculated according to a ratio of a data volume (both the terminal device and the network device may acquire the data volume of the control instruction) of the control instruction to the transmission rate C. For example, time durations elapsed for sending the control instruction to smart device 1, smart device 2 and smart device 3 are respectively 0.1 s, 0.5 s and 1 s.

Time differences between the multiple smart devices are calculated according to the calculate time. For example, time differences between smart device 1, smart device 2 and smart device 3 are 0.5 s and 0.9 s.

Step 14: The network device formulates a uniform control policy for the multiple smart devices according to the time differences.

For example, the formulated uniform control policy is sending a switch instruction to smart terminal 3, sends a switch instruction to smart device 2 0.5 s later, and sends a switch instruction to smart device 0.9 s later.

Alternatively, the formulated uniform control policy is simultaneously sending a switch instruction to the three smart devices, wherein the instruction content is different, which indicates that a switch operation is performed for smart device 3 immediately, and a switch operation is performed for smart device 2 0.5 s later, and a switch operation is performed for smart device 1 0.9 s later.

Step 15: The network device controls the multiple smart devices according to the uniform control policy.

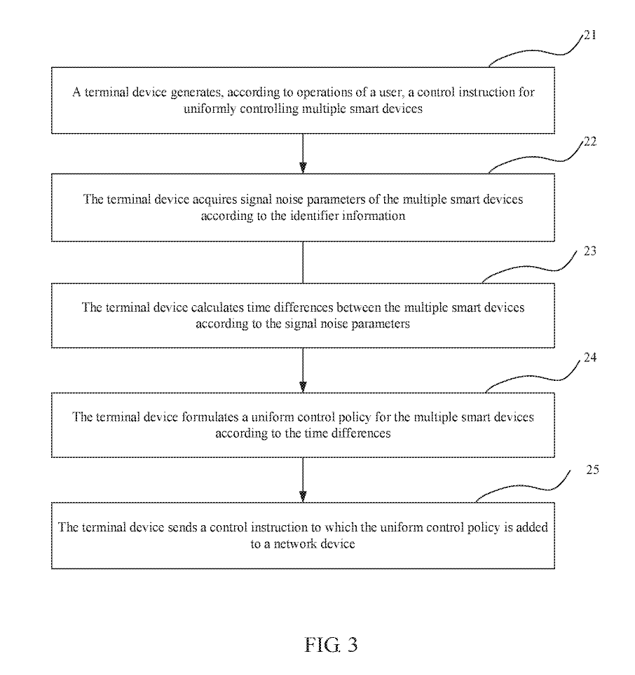

An embodiment of the present invention provides a method for uniformly controlling multiple smart devices. An enforcement object of the method is a terminal device, for example, a mobile phone, a tablet computer or the like. As illustrated in FIG. 3, the method includes the following steps:

Step 21: A terminal device generates, according to operations of a user, a control instruction for uniformly controlling the multiple smart devices, the control instruction including identifier information of the multiple smart devices to be controlled.

Specifically, the user may perform the user may perform the operations via an App installed on the terminal device, wherein the App has a graphical user operation interface, and the user may select, via the interface, the multiple smart devices to be controlled; and the terminal device generates the control instruction according to the operations of the user, and sends the control instruction to the network device. The identifier information may be unique device identifiers (UDIDs) of the multiple smart devices or other identifier information identifying the multiple smart devices.

Step 22: The terminal device acquires signal noise parameters of the multiple smart devices according to the identifier information.

Specifically, the terminal sends a signal noise parameter acquisition request to a network device according to the identifier information; the terminal device receives the signal noise parameters sent by the network device, wherein the signal noise parameters of the multiple smart devices include signal voltages Vs and noise voltages Vn of the multiple smart devices.

Step 23: The terminal device calculates time differences between the multiple smart devices according to the signal noise parameters.

A transmission rate C of the multiple smart devices is calculated according to Shannon's formula C=B*Log2(1+S/N), wherein B denotes a channel bandwidth, signal-to-noise ratio S/N=Ps/Pn=Vs/Vn. For example, in a radio frequency band of 2.4 GHz, bandwidth B of a WiFi channel is 22 MHz, bandwidth B of a Bluetooth channel is 1 MHz, and bandwidth B of a Zigbee channel is 5 MHz.

Time elapsed for sending the control instruction to the multiple smart devices is calculated according to a ratio of a data volume (both the terminal device and the network device may acquire the data volume of the control instruction) of the control instruction to the transmission rate C. For example, time durations elapsed for sending the control instruction to smart device 1, smart device 2 and smart device 3 are respectively 0.1 s, 0.5 s and 1 s.

Time differences between the multiple smart devices are calculated according to the calculate time. For example, time differences between smart device 1, smart device 2 and smart device 3 are 0.5 s and 0.9 s.

Step 24: The terminal device formulates a uniform control policy for the multiple smart devices according to the time differences.

For example, the formulated uniform control policy is sending a switch instruction to smart terminal 3, sends a switch instruction to smart device 2 0.5 s later, and sends a switch instruction to smart device 0.9 s later.

Alternatively, the formulated uniform control policy is simultaneously sending a switch instruction to the three smart devices, wherein the instruction content is different, which indicates that a switch operation is performed for smart device 3 immediately, and a switch operation is performed for smart device 2 0.5 s later, and a switch operation is performed for smart device 1 0.9 s later.

Step 25: The terminal device is configured to send a control instruction to which the uniform control policy is added, such that the network device controls the multiple smart devices according to the uniform control policy.

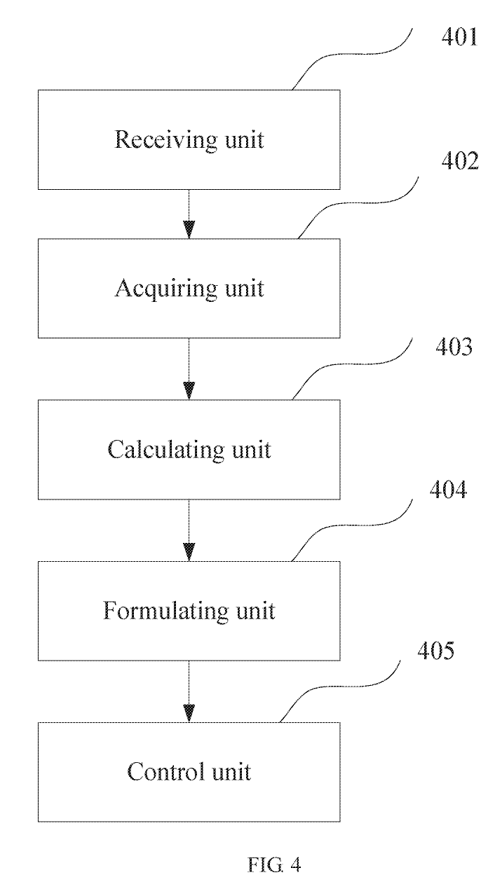

An embodiment of the present invention further provides a network device. As illustrated in FIG. 4, the network device includes:

a receiving unit 401, configured to receive a control instruction for uniformly controlling the multiple smart devices, the control instruction including identifier information of the multiple smart devices to be controlled;

an acquiring unit 402, configured to acquire signal noise parameters of the multiple smart devices according to the identifier information;

a calculating unit 403, configured to calculate time differences between the multiple smart devices according to the signal noise parameters;

a formulating unit 404, configured to formulate a uniform control policy for the multiple smart devices according to the time differences; and

a control unit 405, configured to control the multiple smart devices according to the uniform control policy.

Optionally, the signal noise parameters of the multiple smart devices include signal voltages Vs and noise voltages Vn of the multiple smart devices, and the calculating unit 403 specifically includes a transmission rate calculating module, a time calculating module and a time difference calculating module, wherein

the transmission rate calculating module is configured to calculate a transmission rate C of the multiple smart devices according to Shannon's formula C=B*Log2(1+S/N), wherein B denotes a channel bandwidth, signal-to-noise ratio S/N=Ps/Pn=Vs/Vn;

the time calculating module is configured to calculate, according to a ratio of a data volume of the control instruction to the transmission rate C, time elapsed for sending the control instruction to the multiple smart devices; and

the time difference calculating module is configured to calculate the time differences between the multiple smart devices according to the calculate time.

Optionally, the receiving unit 401 is further configured to, prior to receiving the control instruction, receive registration messages sent by the multiple smart devices, the registration messages including the identifier information and the signal noise parameters;

the network device further includes a storage unit, configured to store the identifier information and the signal noise parameters; and

the acquiring unit 402 is specifically configured to search, in the stored signal noise parameters, for signal noise parameters corresponding to the identifier information.

Optionally, the receiving unit 401 is further configured to, prior to receiving the control instruction, receive registration messages sent by the multiple smart devices, the registration messages including the identifier information;

the network device further includes a storage unit, configured to store the identifier information; and

the acquiring unit 402 specifically includes a sending module and a receiving module, wherein the sending module is configured to send a signal noise parameter acquisition request to the multiple smart devices according to the identifier information, and the receiving module is configured to receive the signal noise parameters sent by the multiple smart devices.

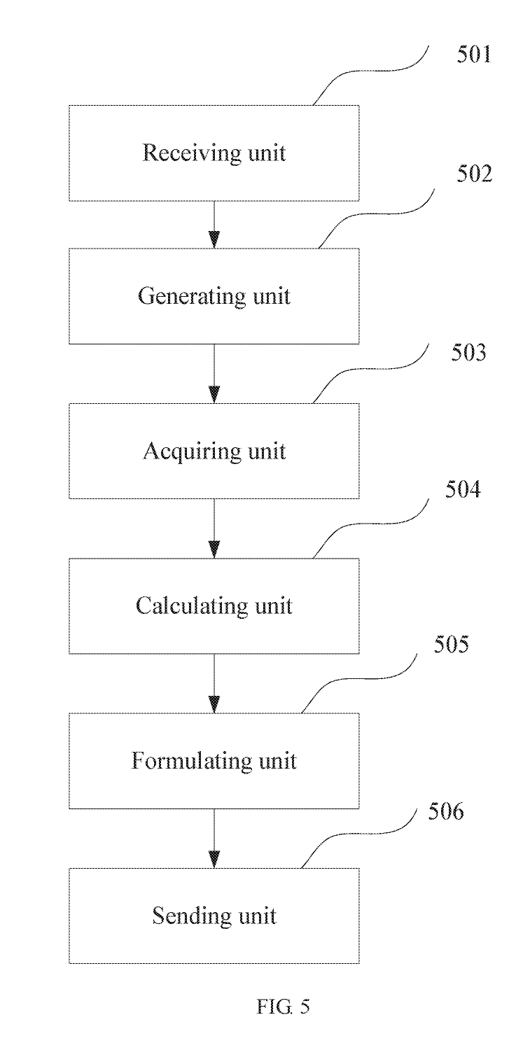

An embodiment of the present invention further provides a terminal device. As illustrated in FIG. 5. the terminal device includes:

a receiving unit 501, configured to receive operations of a user for uniformly controlling multiple smart devices;

a generating unit 502, configured to generate a control instruction for uniformly controlling the multiple smart devices according to the operations of the user, the control instruction including identifier information of the multiple smart devices to be controlled;

an acquiring unit 503, configured to acquire signal noise parameters of the multiple smart devices according to the identifier information;

a calculating unit 504, configured to calculate time differences between the multiple smart devices according to the signal noise parameters;

a formulating unit 505, configured to formulate a uniform control policy for the multiple smart devices according to the time differences; and

a sending unit 506, configured to send a control instruction to which the uniform control policy is added, such that the network device controls the multiple smart devices according to the uniform control policy.

Optionally, the signal noise parameters of the multiple smart devices include signal voltages Vs and noise voltages Vn of the multiple smart devices, and the calculating unit 504 specifically includes a transmission rate calculating module, a time calculating module and a time difference calculating module, wherein

the transmission rate calculating module is configured to calculate a transmission rate C of the multiple smart devices according to Shannon's formula C=B*Log2(1+S/N), wherein B denotes a channel bandwidth, signal-to-noise ratio S/N=Ps/Pn=Vs/Vn;

the time calculating module is configured to calculate, according to a ratio of a data volume of the control instruction to the transmission rate C, time elapsed for sending the control instruction to the multiple smart devices; and

the time difference calculating module is configured to calculate the time differences between the multiple smart devices according to the calculate time.

Optionally, the acquiring unit 503 specifically includes a sending module and a receiving module, wherein the sending module is configured to send a signal noise parameter acquisition request to the network device according to the identifier information, and the receiving module is configured to receive the signal noise parameters sent by the network device.

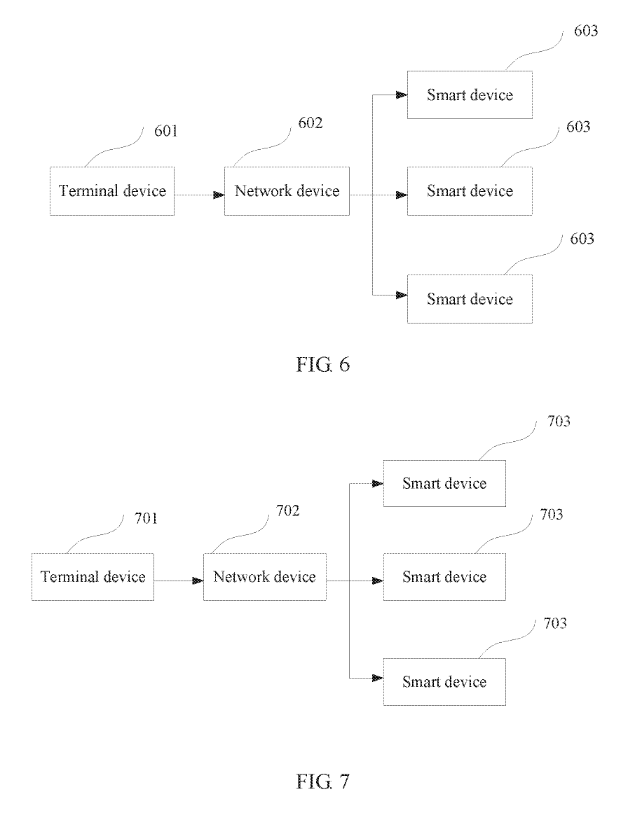

An embodiment of the present invention further provides a system for uniformly controlling multiple smart devices. As illustrated in FIG. 6, the system includes: a terminal device 601, a network device 602 and the multiple smart devices 603; wherein

the terminal device 601 is configured to generate, according to operations of a user, a control instruction for uniformly controlling the multiple smart devices 603, and send the control instruction to the network device 602, the control instruction including identifier information of the multiple smart devices to be controlled; and

the network device 602 is configured to: acquire signal noise parameters of the multiple smart devices according to the identifier information, calculate time differences between the multiple smart devices according to the signal noise parameters, formulate a uniform control policy for the multiple smart devices according to the time differences, and control the multiple smart devices 603 according to the uniform control policy.

Optionally, the multiple smart devices include signal voltages Vs and noise voltages Vn of the multiple smart devices, and the network device 602 is specifically configured to:

calculate a transmission rate C of the multiple smart devices according to Shannon's formula C=B*Log2(1+S/N), wherein B denotes a channel bandwidth, signal-to-noise ratio S/N=Ps/Pn=Vs/Vn;

calculate, according to a ratio of a data volume of the control instruction to the transmission rate C, time elapsed for sending the control instruction to the multiple smart devices; and

calculate the time differences between the multiple smart devices according to the calculated time.

An embodiment of the present invention further provides a system for uniformly controlling multiple smart devices. As illustrated in FIG. 7, the system includes: a terminal device 701, a network device 702 and the multiple smart devices 703; wherein

the terminal device 701 is configured to: receive operations of a user for uniformly controlling multiple smart devices, and generate, according to the operations of the user, a control instruction for uniformly controlling the multiple smart devices 703, the control instruction including identifier information of the multiple smart devices to be controlled; and

the terminal device 701 is further configured to: acquire signal noise parameters of the multiple smart devices according to the identifier information, calculate time differences between the multiple smart devices according to the signal noise parameters, formulate a uniform control policy for the multiple smart devices according to the time differences, and send a control instruction to which the uniform control policy is added to the network device 702 such that the network device 702 controls the multiple smart devices according to the uniform control policy.

Optionally, the multiple smart devices include signal voltages Vs and noise voltages Vn of the multiple smart devices, and the terminal device 701 is specifically configured to:

calculate a transmission rate C of the multiple smart devices according to Shannon's formula C=B*Log2(1+S/N), wherein B denotes a channel bandwidth, signal-to-noise ratio S/N=Ps/Pn=Vs/Vn;

calculate, according to a ratio of a data volume of the control instruction to the transmission rate C, time elapsed for sending the control instruction to the multiple smart devices; and

calculate the time differences between the multiple smart devices according to the calculated time.

The apparatus and system according to the embodiments of the present invention are similar to the method according to the embodiments of the present invention in terms of principles, and the specific details may be referenced to the description of the method embodiments, which are thus not described herein any further.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

1. A method for uniformly controlling multiple smart devices, comprising:
receiving a control instruction for uniformly controlling the multiple smart devices, the control instruction comprising identifier information of the multiple smart devices to be controlled;
acquiring signal noise parameters of the multiple smart devices according to the identifier information;
calculating time differences between the multiple smart devices according to the signal noise parameters;
formulating a uniform control policy for the multiple smart devices according to the time differences; and
controlling the multiple smart devices according to the uniform control policy.

2. The method according to claim 1, wherein the signal noise parameters of the multiple smart devices comprise signal voltages Vs and noise voltages Vn of the multiple smart devices, and the calculating time differences between the multiple smart devices according to the signal noise parameters specifically comprises:
calculating transmission rate C of the multiple smart devices according to Shannon's formula C=B*Log2(1+S/N), wherein B denotes a channel bandwidth, signal-to-noise ratio S/N=Ps/Pn=Vs/Vn;
calculating, according to a ratio of a data volume of the control instruction to the transmission rate C, time elapsed for sending the control instruction to the multiple smart devices; and
calculating the time differences between the multiple smart devices according to the calculated time.

3. The method according to claim 1, wherein prior to the receiving a control instruction for uniformly controlling the multiple smart devices, the method further comprises:
receiving and storing registration messages sent by the multiple smart devices, the registration messages comprising the identifier information and the signal noise parameters; and
the acquiring signal noise parameters of the multiple smart devices according to the identifier information specifically comprises:
searching, in the stored signal noise parameters, for noise parameters corresponding to the identifier information.

4. The method according to claim 1, wherein prior to the receiving a control instruction for uniformly controlling the multiple smart devices, the method further comprises:
receiving and storing registration messages sent by the multiple smart devices, the registration messages comprising the identifier information; and
the acquiring signal noise parameters of the multiple smart devices according to the identifier information specifically comprises:
sending a signal noise parameter acquisition request to the multiple smart devices according to the identifier information; and
receiving the signal noise parameters sent by the multiple smart devices.

5. A network device, comprising:
a receiving unit, configured to receive a control instruction for uniformly controlling the multiple smart devices, the control instruction comprising identifier information of the multiple smart devices to be controlled;
an acquiring unit, configured to acquire signal noise parameters at the multiple smart devices according to the identifier information;
a calculating unit, configured to calculate time differences between the multiple smart devices according to the signal noise parameters;
a formulating unit, configured to formulate a uniform control policy for the multiple smart devices according to the time differences; and
a control unit, configured to control the multiple smart devices according to the uniform control policy.

6. The network device according to claim 5, wherein the signal noise parameters of the multiple smart devices comprise signal voltages Vs and noise voltages Vn of the multiple smart devices, and the calculating unit specifically comprises a transmission rate calculating module, a time calculating module and a time difference calculating module, wherein
the transmission rate calculating module is configured to calculate a transmission rate C of the smart devices according to Shannon's formula C=B*Log2(1+S/N), wherein B denotes a channel bandwidth, signal-to-noise ratio S/N=Ps/Pn=Vs/Vn;
the time calculating module is configured to calculate, according to a ratio of a data volume of the control instruction to the transmission rate C, time elapsed for sending the control instruction to the multiple smart devices; and
the time difference calculating module is configured to calculate the time differences between the multiple smart devices according to the calculated time.

7. The network device according to claim 5, wherein the receiving unit is further configured to, prior to receiving the control instruction, receive registration messages sent by the multiple smart devices, the registration messages comprising the identifier information and the signal noise parameters;
the network device further comprises a storage unit, configured to store the identifier information and the signal noise parameters; and
the acquiring unit is specifically configured to search, in the stored signal noise parameters, for signal noise parameters corresponding to the identifier information.

8. The network device according to claim 5, wherein the receiving unit is further configured to, prior to receiving the control instruction, receive registration messages sent by the multiple smart devices, the registration messages comprising the identifier information;
the network device further comprises a storage unit, configured to store the identifier information; and
the acquiring unit specifically comprises a sending module and a receiving module, wherein the sending module is configured to send a signal noise parameter acquisition request to the multiple smart devices according to the identifier information, and the receiving module is configured to receive the signal noise parameters sent by the multiple smart devices.

9. A terminal device, comprising:
a receiving unit, configured to receive operations of a user for uniformly controlling multiple smart devices;
a generating unit, configured to generate, according to the operations of the user, a control instruction for uniformly controlling the multiple smart devices, the control instruction comprising identifier information of the multiple smart devices to be controlled;
an acquiring unit, configured to acquire signal noise parameters of the multiple smart devices according to the identifier information;
a calculating unit, configured to calculate time differences between the multiple smart devices according to the signal noise parameters;
a formulating unit, configured to formulate a uniform control policy for the multiple smart devices according to the time differences; and
a sending unit, configured to send a control instruction to which the uniform control policy is added, such that the network device controls the multiple smart according to the uniform control policy.

10. The terminal device according to claim 9, wherein the signal noise parameters of the multiple smart devices comprise signal voltages Vs and noise voltages Vn of the multiple smart devices, and the calculating unit specifically comprises a transmission rate calculating module, a time calculating module and a time difference calculating module, wherein
the transmission rate calculating module is configured to calculate a transmission rate C of the multiple smart devices according to Shannon's formula C=B*Log2(1+S/N), wherein B denotes a channel bandwidth, signal-to-noise ratio S/N=Ps/Pn=Vs/Vn;
the time calculating module is configured to calculate, according to a ratio of a data volume of the control instruction to the transmission rate C, time elapsed for sending the control instruction to the multiple smart devices; and
the time difference calculating module is configured to calculate the time differences between the multiple smart devices according to the calculated time.

11. The terminal device according to claim 9, wherein
the acquiring unit specifically comprises a sending module and a receiving module, wherein the sending module is configured to send a signal noise parameter acquisition request to the network device according to the identifier information, and the receiving module is configured to receive the signal noise parameters sent by the network device.

12. A system for uniformly controlling multiple smart devices, comprising: a terminal device, a network device and the multiple smart devices; wherein
the terminal device is configured to generate, according to operations of a user, a control instruction for uniformly controlling the multiple smart devices, and send the control instruction to the multiple smart devices, the control instruction comprising identifier information of the multiple smart devices to be controlled; and
the network device is configured to: acquire signal noise parameters of the multiple smart to the identifier information, calculate time differences between the multiple smart devices according to the signal noise parameters, formulate a uniform control policy for the multiple smart devices according to the time differences, and control the multiple smart devices according to the uniform control policy.

13. The system according to claim 12, wherein the signal noise parameters of the multiple smart devices comprise signal voltages Vs and noise voltages Vn of the multiple smart devices, and the network device is specifically configured to:
calculate a transmission rate C of the multiple smart devices according to Shannon's formula C=B*Log2(1+S/N), wherein B denotes a channel bandwidth signal-to-noise ratio S/N=Ps/Pn=Vs/Vn;
calculate, according to a ratio of a data volume of the control instruction to the transmission rate C, time elapsed for sending the control instruction to the multiple smart devices; and
calculate the time differences between the multiple smart devices according to the calculated time.

14. A system for uniformly controlling multiple smart devices, comprising: a terminal device, a network device and the multiple smart devices; wherein
the terminal device is configured to: receive operations of a user for uniformly controlling multiple smart devices, and generate, according to the operations of the user, a control instruction for uniformly controlling the multiple smart devices, the control instruction comprising identifier information of the multiple smart devices to be controlled; and
the terminal device is further configured to: acquire signal noise parameters of the multiple smart devices according to the identifier information, calculate time differences between the multiple smart devices according to the signal noise parameters, formulate a uniform control policy for the multiple smart devices according to the time differences, and send a control instruction to which the uniform control policy is added to the network device such that the network device controls the multiple smart devices according to the uniform control policy.

15. The system according to claim 14, wherein the signal noise parameters of the multiple smart devices comprise signal voltages Vs and noise voltages Vn of the multiple smart devices, and the terminal device is specifically configured to:
calculate a transmission rate C of the multiple small devices according to Shannon's formula C=B*Log2(1+S/N), wherein B denotes a channel bandwidth, signal-to-noise ratio S/N=Ps/Pn=Vs/Vn;
calculate, according to a ratio of a data volume of the control instruction to the transmission rate C, time elapsed for sending the control instruction to the multiple smart devices; and
calculate the time differences between the multiple smart devices according to the calculated time.
